(19) United States
(12) Patent Application Publication
(10) Pub. No.: US 2022/0122115 A1
(43) Pub. Date: Apr. 21, 2022

(54) INFORMATION MANAGEMENT APPARATUS AND WORK SYSTEM

(71) Applicant: HONDA MOTOR CO., LTD., Tokyo (JP)

(72) Inventors: Makoto YAMANAKA, Wako-shi (JP); Takayuki SATO, Wako-shi (JP); Susumu OKUBO, Wako-shi (JP); Minami KIGAMI, Wako-shi (JP); Yuki MATSUI, Wako-shi (JP)

(21) Appl. No.: 17/492,909

(22) Filed: Oct. 4, 2021

(30) Foreign Application Priority Data
Oct. 21, 2020 (JP) 2020-176884

(51) Int. Cl. G06Q 30/02; G07C 5/00; G06Q 10/00

(52) U.S. Cl. CPC G06Q 30/0236; H04L 67/12; G06Q 10/20; G07C 5/006

(57) ABSTRACT

An information management apparatus that manages information on a self-propelled work machine, the apparatus comprising a registration unit that registers one or more users, a receiving unit that receives a predetermined request from the work machine, a notification unit that notifies the registered one or more users of the request, and a providing unit that provides an incentive to a user who has responded to the request, the user being among the registered one or more users.

### CROSS-REFERENCE TO RELATED APPLICATION(S)

This application claims priority to and the benefit of Japanese Patent Application No. 2020-176884 filed on Oct. 21, 2020, the entire disclosure of which is incorporated herein by reference.

### BACKGROUND OF THE INVENTION

### Field of the Invention

The present invention mainly relates to an information management apparatus.

### Description of the Related Art

In a work system including a self-propelled work machine that performs work in a work area and an information management apparatus that manages information on the work machine, when maintenance or the like of the work machine is necessary, notification to that effect may be provided to a user (see International Publication No. 2016/140236 and CN110122045).

There is a case where, in the above-described work system, an owner is absent for a long period of time (for example, a case where a garden of a villa is a work area). It is conceivable that appropriate maintenance of the work area may be required even in such a case. Meanwhile, it is also conceivable that the work machine will be operated to periodically perform work during the absence of the owner. However, in that case, when the above-described notification is provided, the owner who is absent is forced to access the work machine. Thus, there is room for improvement in terms of usability.

### SUMMARY OF THE INVENTION

An illustrative object of the present invention is to improve usability of a work system.

One of the aspects of the present invention provides an information management apparatus that manages information on a self-propelled work machine, the apparatus comprising a registration unit that registers one or more users, a receiving unit that receives a predetermined request from the work machine, a notification unit that notifies the registered one or more users of the request, and a providing unit that provides an incentive to a user who has responded to the request, the user being among the registered one or more users.

Further features of the present invention will become apparent from the following description of exemplary embodiments with reference to the attached drawings.

### BRIEF DESCRIPTION OF THE DRAWINGS

FIG. 1 is a schematic diagram showing a configuration example of a work system according to an embodiment; and

FIG. 2 is a flowchart showing an example of a work mode.

### DESCRIPTION OF THE EMBODIMENTS

Hereinafter, an embodiment will be described in detail with reference to the accompanying drawings. Note that the following embodiment does not limit the invention according to the claims, and not all combinations of features described in the embodiment are essential to the invention. Two or more of a plurality of the features described in the embodiment may be freely combined. In addition, the same or similar constituent elements are denoted by the same reference numerals, and redundant description will be omitted.

(Configuration Example of Work System)

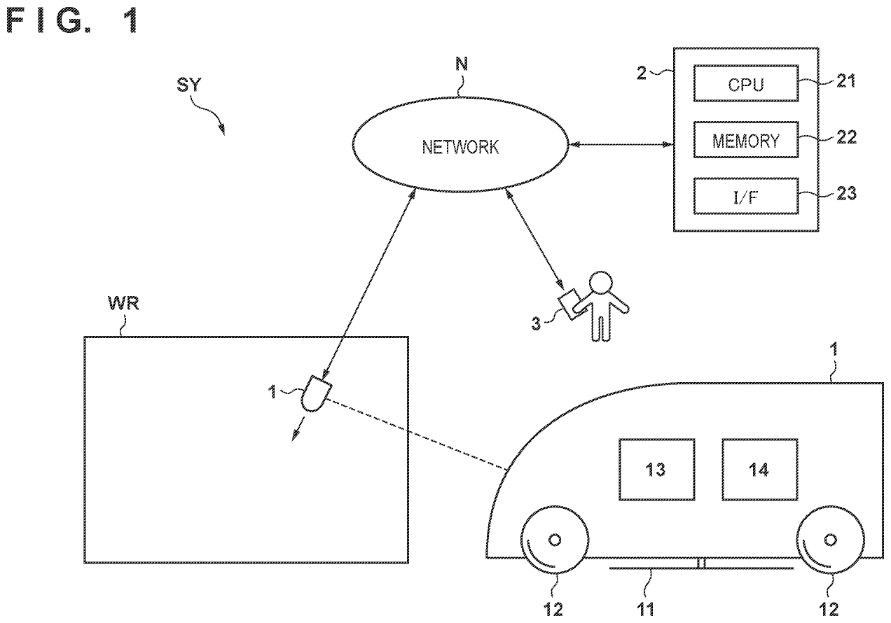

FIG. 1 shows a configuration example of a work system SY according to an embodiment. The work system SY includes a work machine 1, an information management apparatus 2, and a terminal 3. In the present embodiment, the work machine 1 is a self-propelled work machine or an unmanned traveling work machine, and performs work while traveling in a work area WR on a travel route based on a predetermined program. In the present embodiment, the work machine 1 is a lawn mower that performs lawn mowing work. Meanwhile, as another embodiment, the work machine 1 may be, for example, a snow blower that performs snow removal work, or an agricultural work machine that performs agricultural work.

The information management apparatus 2 is a server configured to be capable of communicating with the work machine 1 via a network N. The information management apparatus 2 includes a CPU 21, a memory 22, and a communication interface 23, and thus manages work information on the work machine 1. Details will be described below.

The terminal 3 is a communication device (for example, a mobile terminal such as a smartphone) configured to be capable of communicating with the information management apparatus 2 via the network N. For example, an owner of the work machine 1 can set or input work information, or change the work information by using the terminal 3.

Thus, in the work system SY, the work machine 1, the information management apparatus 2, and the terminal 3 can perform work desired for the work area WR while communicating with each other. As another embodiment, some or all of functions of the information management apparatus 2 may be provided in the work machine 1 and/or the terminal 3. As still another embodiment, a function of the terminal 3 may be provided in the work machine 1 and/or the information management apparatus 2.

(Configuration Example of Work Machine)

The work machine 1 includes a work unit 11, a traveling unit 12, a system controller 13, and a battery 14. The work unit 11 is configured to be capable of actually performing work (lawn mowing work in the present embodiment). A rotary lawn mowing blade that can be raised and lowered is used as the work unit 11. For example, the work unit 11 is put in an operating state and descends to perform lawn mowing work at the time of performing the work, and is raised and put in a stopped state to stop or control the lawn mowing work at the time of suspending the work.

The traveling unit 12 refers to wheels for causing the work machine 1 (main body of the work machine 1) to travel. In the present embodiment, a pair of rear wheels as drive wheels and a pair of front wheels as driven wheels are used as the traveling unit 12. Meanwhile, as another embodiment, another traveling mechanism such as a crawler traveling body (crawler traveling mechanism) may be used as the traveling unit 12.

The system controller 13 is configured to be capable of controlling an entire system of the work machine 1. For example, the system controller 13 controls the driving of the work unit 11 and the traveling unit 12. In the present embodiment, the system controller 13 is a computer including a central processing unit (CPU), a memory, and a communication interface. Meanwhile, as another embodiment, the system controller 13 may include a semiconductor device such as an application specific integrated circuit (ASIC). That is, the function of the system controller 13 can be implemented by either hardware or software.

The battery 14 supplies power to the work unit 11, the traveling unit 12, and the system controller 13. For example, a secondary battery such as a lithium-ion battery can be used as the battery 14. The battery 14 is charged by electric connection of the work machine 1 to a predetermined charger. The charger can be installed at a standby position in the work area WR, the standby position being also referred to as a station or the like.

(Configuration Example of Information Management Apparatus)

The information management apparatus 2 manages information on the work machine 1 while communicating with the work machine 1. The information management apparatus 2 also communicates with the terminal 3 as necessary. In the present embodiment, the information management apparatus 2 is a server including the CPU 21, the memory 22, and the communication interface 23, and the functions of the information management apparatus 2 are implemented by execution of predetermined programs. Note that, as with the system controller 13, the functions of the information management apparatus 2 can be implemented by either hardware or software.

The information management apparatus 2 manages details of work to be performed by the work machine 1. Examples of the details of work include a work schedule (start time, finish time, and the like), the progress of the work (a part of the work area WR where the work has been completed, and the like), and information necessary for execution of the work (parameters to be used for execution of the work, and the like). The owner of the work machine 1 can set the work schedule in advance by using the terminal 3.

For example, the information management apparatus 2 includes a database in which one or more users are registered. When the work machine 1 issues some kind of request, the information management apparatus 2 provides the one or more users with notification based on the request. Details will be described below.

(Service Mode During Absence of Owner)

It is conceivable that the work machine 1 cannot continue work due to an unpredictable event having occurred while the work machine 1 is performing the work. As an example, it is conceivable that in the work area WR, an event that may hinder the work may subsequently occur, so that the work machine 1 cannot move. As another example, it is conceivable that a relatively large load may be applied to the work unit 11, so that the work unit 11 cannot perform the work.

Meanwhile, the owner is not always in the work area WR, and the owner may be absent for a long period of time. In such a case, since it is difficult for the owner of the work machine 1 to access the work machine 1, it is difficult to appropriately maintain the work area WR. Therefore, there may be demand for a service that enables appropriate maintenance of the work area WR without forcing the owner to access the work machine 1. This service is simply referred to as a “service” in the following description.

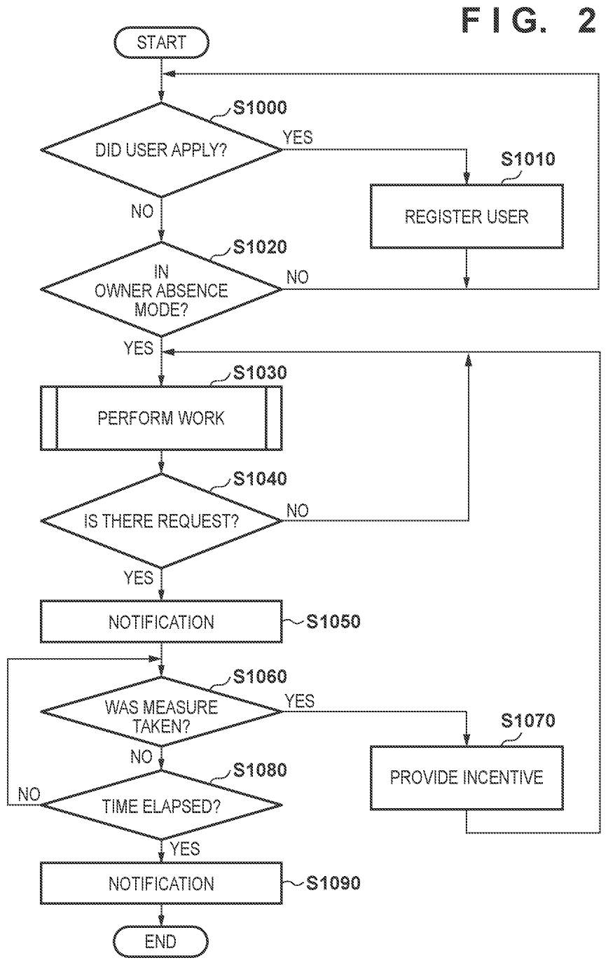

FIG. 2 is a flowchart illustrating a work mode of the work machine 1 during the absence of the owner of the work machine 1. A process described in the present flowchart is mainly performed by the information management apparatus 2. The process can be outlined as follows: when receiving a predetermined request from the work machine 1, the information management apparatus 2 notifies the one or more users of the request, and provide an incentive to a user who has responded to the request.

In the present embodiment, operation modes of the work machine 1 and the information management apparatus 2 include a normal mode and an owner absence mode. In the normal mode, when the work machine 1 cannot continue work due to occurrence of an unpredictable event, the owner is provided with notification to that effect. In the owner absence mode, when the work machine 1 cannot continue work due to occurrence of an unpredictable event, notification to that effect is provided to a user (a third party other than the owner) to be described below.

In step S1000 (hereinafter, simply referred to as S1000, and the same applies to other steps to be described below), it is determined whether any third party has applied to be a user. The user described herein refers to a user of the present service, and is a third party other than the owner of the work machine 1. When desiring to use the present service, any third party can apply to be a user, and user registration to be described below is performed after predetermined approval. When any third party has applied to be a user, the process proceeds to S1010. Otherwise, the process proceeds to S1020.

User registration is performed in S1010, and the process returns to S1000. In the user registration, a third party who has applied to be a user is registered as a user of the present service. At that time, the name of the user, the e-mail address of a mobile terminal, a bank account, and the like are registered in the present embodiment.

In S1020, it is determined whether the owner absence mode has been established. For example, when the owner of the work machine 1 is absent for a long period of time, the owner can put the work machine 1 and the information management apparatus 2 into the owner absence mode by using the terminal 3. Note that it is sufficient that one or more users are registered, and the present embodiment is based on the assumption that the owner absence mode cannot be established unless one or more users are registered.

In S1030, work is performed on the basis of a preset work schedule, the progress of the work, information necessary for execution of the work, and the like. Note that, since the mode of the work is publicly known, description thereof is omitted here.

In S1040, it is determined whether there is a request from the work machine 1 in operation. The work machine 1 can conduct a predetermined self-diagnosis, and the information management apparatus 2 can receive a request based on a result of the diagnosis. Details will be described below. When the request is received from the work machine 1, the process proceeds to S1050. Otherwise, the process returns to S1030 to continue the work based on the work schedule.

In S1050, on the basis of the request from the work machine 1, the request (or the content of the request) is notified to the user registered in S1010. This notification just needs to be transmitted to the user's mobile terminal. Note that, here, for the sake of simplicity, the above-described notification is to be transmitted to all of the one or more users registered in S1010, but may be transmitted only to some users relatively close to the work area WR.

In S1060, it is determined whether any user who has received the notification in S1050 has taken measures in response to the request from the work machine 1. This determination may be made on the basis of a signal received from the work machine 1, the signal indicating that measures have been taken. Alternatively, the determination may be made on the basis of a signal to the same effect received from a user who has taken the measures. In S1060, it is desirable to determine collaterally whether the measures have been appropriately taken. It is possible to make this determination by, for example, determining whether the work may be resumed in S1030, on the basis of the self-diagnosis conducted by the work machine 1. When the measures have been appropriately taken, the process proceeds to S1070. Otherwise, the process proceeds to S1080.

In S1070, an incentive is provided to the user who has taken the above-described measures. Incentives corresponding to the content of requests are set in advance, and monetary incentives are set in the present embodiment. Details will be described below.

In S1080, it is determined whether predetermined time has elapsed. Time to be used as a basis, such as 10 minutes, 30 minutes, or one hour, is to be preset by the owner of the work machine 1 by means of the terminal 3. When the predetermined time has elapsed, the process proceeds to S1090. Otherwise, the process returns to S1060.

In S1090, it is determined that there has been no user who could take measures in response to the request mentioned in S1040, and notification to that effect is provided to the owner. Thus, the present flowchart ends.

According to such a work mode, in a case where it is difficult for the owner of the work machine 1 to access the work machine, it is possible to get cooperation from a user (third party) of the service and to be assisted in, for example, restoring the work machine. Furthermore, since a predetermined incentive is provided to the user in compensation for the above-described cooperation, it is possible to expect appropriate cooperation from the user. According to the present embodiment, the owner can respond to the request from the work machine 1 without accessing the work machine 1, so that the usability of the work system SY can be improved.

For the sake of simplicity, the notification provided in S1050 is to be transmitted to all of the one or more users registered in S1010 in the present embodiment, but may be transmitted only to some users relatively close to the work area WR. In this case, location information on the one or more users registered in S1010 may be acquired before S1050. Alternatively, acquisition of the location information and notification in S1050 may be performed substantially at the same time. Typically, the location information can be acquired through communication with the users' mobile terminal. In a case where the location information satisfies a criterion (for example, in a case where the location information indicates a location within a predetermined distance from the work machine 1), the above-described request is transmitted to the corresponding user. As a result, when it is difficult to get the above-described cooperation from a user, it is possible to omit the notification to the user, and thus, it is possible to further improve the usability of the work system SY.

Note that the order of the above flowcharts may be partially changed without departing from the spirit of the present embodiment. For example, according to the present embodiment, after the incentive is provided in S1070, the process returns to S1030 and the work is resumed. Meanwhile, as another embodiment, the incentive may be provided after the work is resumed.

(Content of Request from Work Machine)

Examples of the content of a request from the work machine 1 and an incentive for responding to the request include the following.

### FIRST EXAMPLE

As a first example, it is conceivable that some kind of obstructive factor (or an event that may hinder the work machine 1 from traveling) may subsequently arise in the work area WR, so that the work machine 1 cannot move. Examples of the obstructive factor include installation of an object, appearance of swamp due to rain, unevenness of terrain caused by an earthquake, and natural growth of bushes. It does not matter whether the obstructive factor is natural or artificial as long as the obstructive factor is a factor that hinders the work machine 1 from traveling.

The work machine 1 can detect that the work machine 1 cannot move, by using a known method. Inconsistency between the rotation speed of the wheels (drive wheels in the present embodiment) included in the work machine 1 and the location information (own location on map data) on the work machine 1 can be cited as an example of a mode of the detection. Inconsistency between the rotation speeds of the two or more wheels included in the work machine 1 (the rotation speed of the drive wheels and the rotation speed of the driven wheels in the present embodiment) can be cited as another example of the mode of the detection. Putting the work area WR in good condition is considered a measure to be taken in a case where the work machine 1 cannot move. Elimination of the obstructive factor may be the corresponding measure in the above example. Furthermore, the information management apparatus 2 provide an incentive of, for example, 1,000 to 2,000 yen to a user who has taken such measures. The user can confirm the fact with the terminal 3.

The first example above can be summarized as follows:

Case . . . the work machine 1 cannot move,

Measure . . . putting the work area WR in good condition,

Incentive . . . 1,000 to 2,000 yen.

### SECOND EXAMPLE

As a second example, it is conceivable that a relatively large load may be applied to the work unit 11, so that the work unit 11 cannot perform work. Examples of the load to be applied to the work unit 11 include a relatively hard stone interfering with the work unit 11, and the work unit 11 being entangled in relatively dense weeds.

The work machine 1 can detect that the work unit 11 cannot perform work, by using a known method. A drive current (for example, a motor current) for driving the work unit 11 exceeding a reference value can be cited as an example of the mode of the detection. Repair of the work unit 11 is considered a measure to be taken in a case where the work unit 11 cannot perform work. Replacement of the work unit 11 may be the corresponding measure in the above example. Furthermore, the information management apparatus 2 provide an incentive of, for example, 5,000 to 10,000 yen to a user who has taken such measures. The user can confirm the fact with the terminal 3.

The second example above can be summarized as follows:

Case . . . the work unit 11 cannot perform work,

Measure . . . repair of the work unit 11,

Incentive . . . 5,000 to 10,000 yen.

### THIRD EXAMPLE

As a third example, it is conceivable that the work machine 1 may be put in a stopped state due to battery exhaustion of the work machine 1 (the remaining capacity of the battery 14 having decreased to an allowable lower limit value or having decreased to or fallen below a reference value).

When the remaining capacity of the battery 14 decreases to the allowable lower limit value, or decreases to or falls below the reference value, the work machine 1 can transmit a signal indicating the fact as the above-described request. Note that the work machine 1 may further include a sub-battery that accompanies the battery 14, and it is also possible for the work machine 1 to transmit the signal by using power from the sub-battery. Electrically connecting the work machine 1 to a charger is considered a measure against the battery exhaustion of the work machine 1. Moving to a station in the work area WR may be the corresponding measure in the above example. Furthermore, the information management apparatus 2 provide an incentive of, for example, 1,000 yen to a user who has taken such measures. The user can confirm the fact with the terminal 3.

The third example above can be summarized as follows:

Case . . . battery exhaustion,

Measure . . . electrically connecting the work machine 1 to a charger,

Incentive . . . 1,000 yen.

Some incentives have been illustrated in the first to third examples above. Meanwhile, the incentive is not limited to the above examples as long as the incentive is set based on the content of a request. In addition, while monetary incentives have been provided here as examples of incentives that can be typically employed, other types of incentive such as a social incentive may be employed.

Furthermore, in the case of a monetary incentive, a bank account of the owner of the work machine 1 is registered in the information management apparatus 2, so that a corresponding incentive just needs to be provided from the bank account to a user who has taken measures.

In the above description, for ease of understanding, each element has been given a name related to its functional aspect. Meanwhile, each element is not limited to one having, as a main function, the function described in the embodiment, and may be one having the function as an auxiliary function.

Each feature of the embodiment can be summarized as follows.

A first aspect relates to an information management apparatus (for example, 2), and the information management apparatus is an information management apparatus that manages information on a self-propelled work machine (for example, 1), the apparatus including: a registration unit (for example, S1010) that registers one or more users; a receiving unit (for example, S1040) that receives a predetermined request from the work machine; a notification unit (for example, S1050) that notifies the registered one or more users of the request; and a providing unit (for example, S1070) that provides an incentive (for example, a monetary incentive) to a user who has responded to the request, the user being among the registered one or more users.

As a result, in a case where it is difficult for the owner of the work machine to access the work machine, it is possible to get cooperation from a third party who is the registered user and to be assisted in, for example, restoring the work machine. Furthermore, since a predetermined incentive is provided to the third party in compensation for the above-described cooperation, it is possible to expect appropriate cooperation from the third party. Therefore, according to the first aspect, the owner of the work machine can respond to the request from the work machine without accessing the work machine, so that the usability of the work system can be improved.

According to a second aspect, the receiving unit further receives a signal indicating that the request has been handled (for example, S1060), and the providing unit provides the incentive to the user who has responded to the request, according to the received signal.

As a result, the first aspect described above can be appropriately implemented.

According to a third aspect, the receiving unit receives, from the work machine, the signal indicating that the request has been handled.

As a result, the first aspect described above can be appropriately implemented.

According to a fourth aspect, the receiving unit receives the signal indicating that the request has been handled, from the user who has responded to the request.

As a result, the first aspect described above can be appropriately implemented.

According to a fifth aspect, the incentive is set based on a content of the request.

As a result, a reward is paid as the above-described incentive to a third party in accordance with details of cooperation.

According to a sixth aspect, the incentive is a monetary incentive.

As a result, the fifth aspect described above can be appropriately implemented. While a monetary incentive is an example of an incentive that can be typically employed, other types of incentive such as a social incentive may be employed.

According to a seventh aspect, the registration unit further registers a bank account of an owner of the work machine, and the providing unit provides the monetary incentive to the user who has responded to the request, the monetary incentive being provided from the bank account.

As a result, the fifth aspect described above can be appropriately implemented.

An eighth aspect relates to a work system (for example, SY), and the work system includes: the above-described information management apparatus (for example, 2); and a work machine (for example, 1) capable of communicating with the information management apparatus.

That is, the above-described information management apparatus can be applied to a typical work system.

According to a ninth aspect, the work machine outputs the request to the information management apparatus based on a fact that the work machine cannot continue work.

As a result, the eighth aspect described above can be appropriately implemented.

According to a tenth aspect, the work machine outputs the request to the information management apparatus based on a fact that a remaining capacity of a battery included in the work machine has decreased to an allowable lower limit value.

As a result, the eighth aspect described above can be appropriately implemented.

According to an eleventh aspect, the request is to ask that the work machine be moved to a desired position.

While the desired position may be freely set by the owner, a station where the work machine 1 can be electrically connected to a charger has been cited as an example of the desired position in the embodiment.

According to a twelfth aspect, the work machine outputs the request to the information management apparatus based on inconsistency between a rotation speed of a wheel included in the work machine and location information on the work machine.

As a result, the eighth aspect described above can be appropriately implemented.

According to a thirteenth aspect, the work machine outputs the request to the information management apparatus based on inconsistency between a rotation speed of a drive wheel included in the work machine and a rotation speed of a driven wheel included in the work machine.

As a result, the eighth aspect described above can be appropriately implemented.

According to a fourteenth aspect, the information management apparatus further includes an acquisition unit that acquires location information on the registered one or more users, and when the location information on any of the registered one or more users satisfies a criterion, the notification unit notifies the any of the registered one or more users of the request, the location information being acquired by the acquisition unit.

A case where the location information indicates a location within a predetermined distance from the work machine can be cited as an example of a case where the location information satisfies a criterion. Thus, when it is difficult to get the above-described cooperation from a user, the notification to the user is omitted. As a result, it is also possible to further improve the usability of the work system.

The invention is not limited to the foregoing embodiments, and various variations/changes are possible within the spirit of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information management apparatus that manages information on a self-propelled work machine, the apparatus comprising:
a registration unit that registers one or more users;
a receiving unit that receives a predetermined request from the work machine;
a notification unit that notifies the registered one or more users of the request; and
a providing unit that provides an incentive to a user who has responded to the request, the user being among the registered one or more users.

2. The information management apparatus according to claim 1, wherein
the receiving unit further receives a signal indicating that the request has been handled, and
the providing unit provides the incentive to the user who has responded to the request, according to the received signal.

3. The information management apparatus according to claim 2, wherein
the receiving unit receives, from the work machine, the signal indicating that the request has been handled.

4. The information management apparatus according to claim 2, wherein
the receiving unit receives the signal indicating that the request has been handled, from the user who has responded to the request.

5. The information management apparatus according to claim 1, wherein
the incentive is set based on a content of the request.

6. The information management apparatus according to claim 1, wherein
the incentive is a monetary incentive.

7. The information management apparatus according to claim 6, wherein
the registration unit further registers a bank account of an owner of the work machine, and
the providing unit provides the monetary incentive to the user who has responded to the request, the monetary incentive being provided from the bank account.

8. A work system comprising:
the information management apparatus according to claim 1; and
a self-propelled work machine capable of communicating with the information management apparatus.

9. The work system according to claim 8, wherein
the work machine outputs the request to the information management apparatus based on a fact that the work machine cannot continue work.

10. The work system according to claim 9, wherein
the work machine outputs the request to the information management apparatus based on a fact that a remaining capacity of a battery included in the work machine has decreased to an allowable lower limit value.

11. The work system according to claim 10, wherein
the request is to ask that the work machine be moved to a desired position.

12. The work system according to claim 9, wherein
the work machine outputs the request to the information management apparatus based on inconsistency between a rotation speed of a wheel included in the work machine and location information on the work machine.

13. The work system according to claim 9, wherein
the work machine outputs the request to the information management apparatus based on inconsistency between a rotation speed of a drive wheel included in the work machine and a rotation speed of a driven wheel included in the work machine.

14. The work system according to claim 9, wherein
the information management apparatus further includes an acquisition unit that acquires location information on the registered one or more users, and
when the location information on any of the registered one or more users satisfies a criterion, the notification unit notifies the any of the registered one or more users of the request, the location information being acquired by the acquisition unit.
